(19) United States
(12) Patent Application Publication
(10) Pub. No.: US 2005/0125232 A1
(43) Pub. Date: Jun. 9, 2005

(54) Automated speech-enabled application creation method and apparatus

(76) Inventor: I. Michael Gadd, London (GB)

Correspondence Address: OSHA & MAY L.L.P., 1221 MCKINNEY STREET, SUITE 2800, HOUSTON, TX, 77010, US

(21) Appl. No.: 10/977,127

(22) Filed: Oct. 29, 2004

(30) Foreign Application Priority Data
Oct. 31, 2003 (GB) 0325497.6

(51) Int. Cl. G10L 21/00

(52) U.S. Cl. 704/270.1

(57) ABSTRACT

A system for creating and hosting speech-enabled applications having a speech interface that can be customised by a user is disclosed. The system comprises a customisation module that manages the components, e.g. templates, needed to enable the user to create a speech-enabled application. The customisation module allows a non-expert user rapidly to design and deploy complex speech interfaces. Additionally, the system can automatically manage the deployment of the speech-enabled applications once they have been created by the user, without the need for any further intervention by the user or use of the user's own computer processing resources.

### FIELD OF THE INVENTION

The invention relates to an automated speech-enabled application creation method and apparatus. In particular, but not exclusively, it relates to an automated speech-enabled application method and apparatus comprising a client data processing apparatus and a server data processing apparatus that can be operated by a user to create one or more speech-enabled applications (e.g. software applications) that have a speech interface that is programmed or customised by the user.

### BACKGROUND

Over the past few years, there has been a huge growth in the amount of resources that are accessed electronically by various users using voice/speech reliant services. For example, telephone banking, on-demand technical support, telesales and marketing, and various other services all rely on speech interaction with service users, such as customers, to provide an efficient and convenient service.

For reasons of cost efficiency associated with removing the need for human operators, such services are being increasingly provided by automated services reliant upon computer systems running various applications to deliver speech output and to recognise audible speech responses from service users as input. Indeed it is noticeable that recently such systems have become markedly better at simulating the response of a human operator, with increasing speech recognition accuracy and fewer mis-recognitions occurring.

However, although speech-enabled applications for the delivery of a variety of services have improved greatly in recent times, generally the development of such applications remains a difficult, time-consuming and expensive task. One reason for this is that a spoken language interface (SLI) usually requires a skilled technician or engineer for its development. The SLI is an interface that can recognise and convert speech into a form recognisable to an application, such as a software application, and usually also convert output from the application to output, such as speech, that is intelligible to the service users.

The Site Builder Toolkit available from Angel.com of 1861 International Drive, McLean, Va. 22102, U.S.A. (hereinafter referred to as “Angel toolkit”) attempts to remove the need for a user to possess a large amount of expertise in order to develop speech-enabled applications, and so reduce the burden of developing an SLI. However, whilst the Angel toolkit removes some of the burden of interface design and configuration from the user, it is not itself wholly successful in this regard since it still requires that a user has a fair amount of knowledge or experience in order to be able to configure the toolkit by knowing how to interpret and apply relatively low-level configuration commands.

Hence, there still remains the need for an improved way of enabling a user, such as a non-expert, to provide a speech interface for controlling speech-enabled applications.

The present invention has been devised with the disadvantages described herein borne in mind.

### SUMMARY OF THE INVENTION

According to a first aspect of the invention, there is provided a system for creating and hosting user-customisable speech-enabled applications. The system allows a speech interface to be customised by a user. The system comprises a client data processing apparatus, a server data processing apparatus and a customisation module. The client device, for use by a user, and the server are operably coupled. The customisation module is for configuring a speech interface for one or more applications executable on the system. The customisation module is operable to a) receive user input from the client data processing apparatus, b) determine an appropriate template for configuring the application selected by the user, c) retrieve the appropriate template from the server data processing apparatus, and d) generate configuration data for automatically configuring the speech interface of the application selected by the user when that customised application is executed.

By providing templates from the server, the system can be made easier to use by non-experts for a number of reasons. For example, templates can be provided that constrain the complexity of dialogues or grammars that the user can manipulate to create the speech interface. Additionally, the templates can be centrally managed, updated and distributed, which allows a broad range of speech interfaces to be adopted for a large number of different applications. Further, in various embodiments the speech interfaces may be updated at run-time, thereby enabling system-wide updating to be applied. Such system-wide updating may, for example, add new functionality to speech interfaces already created by a user. For example, speech interfaces may be upgraded to apply faster speech recognition models, or add other speech interface improvements such as those described below.

A user can interact with the customisation module via user input provided via the client device, for example, through an Internet or web-based interface. This also allows many users to use the system. The user input can comprise data encoding various information, such as which application the user wishes to define a new speech interface for, or various form information etc., that is used to populate data fields whose structure is provided by an appropriate template.

In various embodiments, the server provides the client with a series of forms based upon a template for a particular software application that are then presented by the client device on a graphical user interface (GUI). The user may select predetermined constrained data or add non-predetermined data to various form fields. Once populated, the data in the form fields may be returned to the server and used subsequently to configure a SLI for the applications as they are executed. A single server may be used to host and deploy many speech-enabled applications created by various different users.

The server may store the configuration data and host customised applications. This allows the customised applications to be managed and executed remotely from the user who created them, and provides a number of benefits. For example, it allows the system to manage and deploy applications created by the user without the user needing to intervene, use their own local processing resources or manage their own database. Also the speech-enabled applications can be executed by the system in an event-driven manner in response to input from a service user. This is the so-called “closed-loop” method of operation.

For example, a service user may telephone a predetermined telephone number that identifies a particular speech-enabled application, language to use etc., and the system may then execute that application to guide the system user through the service provided by the application. In various embodiments, the system records the details of interactions with system users, and reports those details back to the user who created the respective speech-interfaces. Reporting and messaging with system users (e.g. application users, participants, callers etc.) can be achieved using a number of techniques such as, for example, SMS messaging, radio messaging, email messaging, etc.. Such reports and messages may optionally be scheduled in order to enable timed transmission where desired or necessary.

A further benefit of providing a server that centrally deploys the customised applications derives when the system is configured to implement speech related processing that uses adaptive learning (AL) algorithms to improve the system response. Centralising of the deployment of the customised applications ensures that a large volume of speech traffic is handled by the server, and this in turn can be used rapidly to optimise the AL processing. Several processing techniques that rely on AL are discussed further below.

The server may be operable to dynamically generate one or more templates. The customisation module may be operable to check for updated templates when applications are executed and preferentially apply updated templates to respective speech-enabled applications. Templates can be modified to improve the speech interfaces either during or prior to the customisation of a speech interface or during or prior to run-time. The templates can be modified by various AL algorithms. By enabling such a dynamic modification of templates to take place automatically, a user requires even less expert knowledge to be able to create a speech interface using the system. This can also allow templates to be updated without incurring significant amounts of system down-time.

The system may be operable to apply multi-channel disambiguation (MCD) to input provided to a customised application in order to disambiguate the configuration data. MCD is a concept that enables the system to preferentially choose an input channel, e.g. telephone, email etc., in order to optimally identify what a system user is trying to achieve. MCD is one processing technique that can use AL algorithms for its implementation. The concept is more fully described in International Patent Application WO-A1-03/003347, the contents of which are hereby incorporated herein in their entirety.

Use of MCD allows a certain amount of flexibility in speech interface design as it means non-directed dialogue can be employed, which in turn further reduces the burden on the user as it removes need for him to have expertise in speech interface design. Additionally, non-directed dialogue provides a more natural speech interface, as well as reducing data storage requirements for grammars, expected utterances etc.

According to a second aspect of the invention, there is provided a method of creating speech-enabled applications having a speech interface customised by a user. The method comprises receiving user input, determining an appropriate template for configuring an application from the user input, retrieving the appropriate template from a server data processing apparatus, and generating configuration data for automatically configuring a speech interface of an application selected by the user when that customised application is executed.

Analogous method steps to provide functionality similar to that found in the system, described above, may also be provided in connection with this aspect of the invention.

According to a third aspect of the invention, there is provided a program element including program code operable to configure the system or provide the method according to the first or second aspects of the invention. In various embodiments, the program element of the third aspect of the invention is operable to implement a wizard tool for guiding a user through a customisation process. Such a wizard tool makes the creation of speech interfaces by a non-expert user easy.

### BRIEF DESCRIPTION OF THE DRAWINGS

Embodiments of the present invention will now be described, by way of example only, with reference to the accompanying drawings where like numerals refer to like parts and in which:

FIG. 1 is a diagram showing the components of the speech application and supporting systems, including those aspects involving the user, application users or participants, and components comprising a speech application server, according to an embodiment of the invention;

FIG. 2 is a diagram showing data flow involved in the actions and processing of an individual participant response within a system according to an embodiment of the invention;

FIG. 3 schematically shows the architecture of a system according to an embodiment of the invention;

FIG. 4 shows a detailed architectural illustration of a system or method according to an embodiment of the invention;

FIG. 5 is a diagram showing the flow of operations from initial creation to full operation of a speech application including steps of a method according to the present invention;

FIG. 6 is an overview diagram illustrating the concept of a user establishing a speech application directed for use by a plurality of participants using a system and method according to an embodiment of the invention;

FIG. 7 is a flow diagram illustrating the operation of an application for creating a multiple question quiz scenario having a speech interface customised by an embodiment of the invention;

FIG. 8 is an illustration showing a first screen shot provided by a user interface generated by a web-based wizard according to an embodiment of the invention;

FIG. 9 is an illustration showing a second screen shot provided by a user interface generated by a web-based wizard according to an embodiment of the invention;

FIG. 10 is an illustration showing a third screen shot provided by a user interface generated by a web-based wizard according to an embodiment of the invention;

FIG. 11 is an illustration showing a fourth screen shot provided by a user interface generated by a web-based wizard according to an embodiment of the invention; and

FIG. 12 is an illustration showing a fifth screen shot provided by a user interface generated by a web-based wizard according to an embodiment of the invention.

### DETAILED DESCRIPTION

FIG. 1 is a diagram showing major aspects of an example system configured to implement many aspects of the present invention. The flow in this diagram is left to right. The user 201 provides application details for specifying a speech application by creating text for prompts, sound files, movie clips, pictures, recipient contact telephone numbers to be used for alert push messages, and various other configuration settings. These details are specified by interacting with a web portal 202. This portal provides access to a set of web wizard templates to capture the application content and configuration settings from the user.

Once accepted for deployment, the speech application server 203 takes the information provided by the web wizard 202, as designed by the user 201 and automatically generates a natural spoken language interface (SLI) application 200 in accordance with an application specific template. This application consists of a number of speech processing system components. These components may include a provision component 204, where the telephone number for the speech application is defined from a pre-defined list of numbers.

A further speech application component is the automatic grammar generation component (AGG) 205, where the anticipated dialogues are processed to generate optimised grammars, language models and natural language understanding models for the speech recognition systems.

A further speech application component is the scheduled alert trigger system 206. This system triggers SMS messages to be sent to participants using a list of contact numbers supplied by the user and stored in a database or other persistent electronic storage mechanism. The content and timing of the alert messages are specified by the user 201 during application creation.

As the system operates, a further speech application component generates reporting 207 information. This reporting component provides a set of real-time caller activity and statistics, available via the web portal 202. A further speech application component is the call-flow component 208. During the active period, based on the template and content provided by the user, the call flow component creates a call flow defining the structure of the application, the prompts, sounds, pictures and required responses.

A further speech application component is the text-to-speech (TTS) system 209. This component constructs the prompt text in the form of spoken audio output to be played to participants during the calls, in a voice with characteristics as selected by the user 201 at the time of creation using options presented by the web portal 202.

One or more participants 210 are informed and invited to participate using the recipient number list stored in the database, sent out by a number of means, suitably SMS text message alerts. The participants then call the speech application server 203 and interact with the live speech application 200. Alternatively, participants may have been made aware of the speech application by other media.

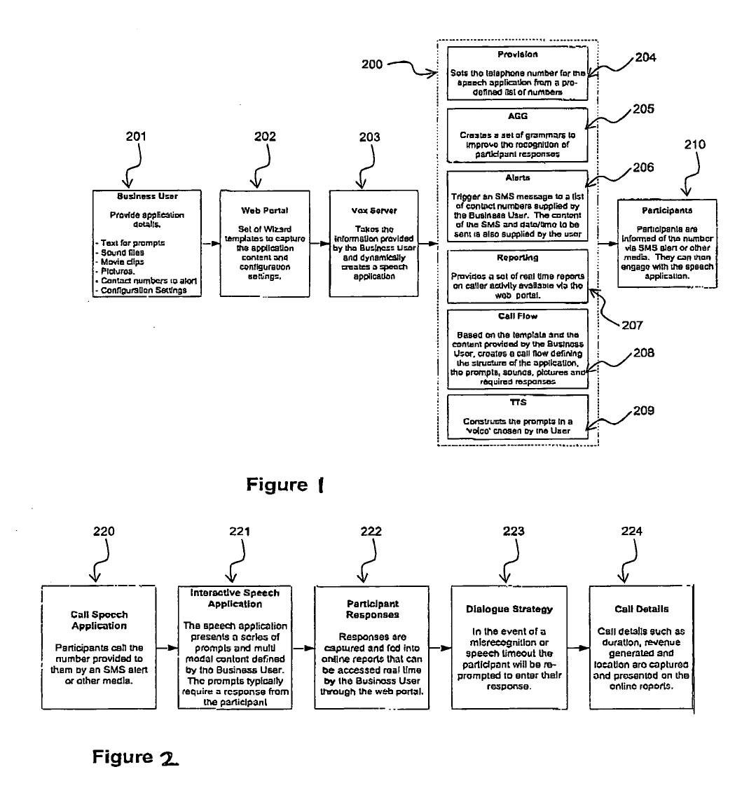

FIG. 2 is a process diagram showing major steps involved in processing a given participant call, engaging with the speech application. The process diagram is intended to be read left to right.

The participants/system users start by calling the speech application 220 number, provided to them by the alert or other promotional messages. The Interactive Speech Application 221 presents a series of prompts and multi-modal (e.g. sound, graphics, text, etc) content defined by the user. The prompts typically require some speech or other response from the participant.

At various points in the call, the participant responses 222 are captured by the spoken language interface application and fed into online reports that can be accessed in real-time by the user through the web portal. In the event of recognition failures or time-out delays 223 the participant will be re-prompted to enter their response again using an alternative dialogue strategy. Once the call is completed, call details 224 such as call duration, revenue generated and location are captured and presented to the user in on-line reports.

As an illustration of the invention in a practical application, the following is described. A holiday company interested to promote holidays to potential holiday purchasers runs a Quiz to give away a holiday as part of a general marketing promotional campaign. The user at the holiday company will start by logging onto the speech application web-wizard website and selecting an application type, such as Quiz.

Once the Quiz template is selected the web-wizard allows the user to type in quiz questions or vote choices, select the sounds or jingles from an available list or upload new sounds, choose start and end dates, upload phone numbers for SMS alerts, choose a tariff for revenue sharing. The user may also select a voice style and any other multi-modal media such as video or pictures.

For every question, a number of possible answers are presented in multiple-choice format. These questions and possible answers are then automatically presented to each participant at the time they call the speech application server. At the end of design process the user pushes a button to instruct the speech application to be deployed.

During the deployment phase, the speech application components are loaded onto a server and configured as specified. At the start time SMS text message alerts are sent out to the lists of mobile participants specified at the start of the marketing campaign creation. The alert messages are timed to coincide with general wider media promotional events. Participants get the text messages; respond by calling in and engage with the quiz application. Once the quiz application is over, the results are reviewed by management at the holiday company and a set of quiz winners is selected.

In the example of a quiz format template, the holiday company might design the interactive voice dialog similar to:

QUIZ EXAMPLE 1: The phone call starts with an introduction to the quiz. Then, the questions for the quiz are presented to the participant. PROMPT: “To win the holiday of a lifetime, answer the following questions” Question One. What is the capital of Australia? Is it Sydney, Melbourne or Canberra.” Participant: “Canberra.” PROMPT: “Correct. Now for the tiebreaker: In no more than 10 seconds describe why you should win the holiday.” Participant: “Because I've never been further South than Croydon.” PROMPT: “Thank you for participating, Goodbye.” Full reports are displayed on the holiday company website, including the details of all the winners, shown in chronological order. The phone number of the winner is captured automatically by the system using caller line identifiers or if they aren't present asking the user.

VOTING EXAMPLE 2: In the same way that a customer would enter quiz questions, the business customer accesses the website to provide a list of all vote categories to be asked. The business customer can provide as many categories as they want. For every category the customer provides a list of possible voting options. PROMPT: “Welcome to the Sports Personality voting line. What is your vote for football player of the year? Is it David Beckham, Sol Campbell or Michael Owen?” Participant: “David Beckham.” PROMPT: “Ok, And what is your vote for the team of the year? Is it Man U, Liverpool or Spurs?” Participant: “Liverpool.” PROMPT: “Thank you for voting. Good bye.” This style of speech application template may be followed by optional request for caller details, in case the company requires follow-up communication. The results of all votes are graphically displayed on the website, and optionally consolidated results may be sent by alert messaging to business user staff.

In addition to details illustrated in the above two examples of Quiz and Vote application styles, a business customer may specify the following details:
1. All prompts—such as the Welcome and Closing message
2. Start and End dates for the campaign
3. Invitation message to be sent as an SMS in a Push Campaign
4. Pricing Model
5. Optional Tiebreaker question

By way of further example embodiment, the methods may involve technical system and software implementation involving the following set of technical processes. It is suggested that such steps will be understood by a person skilled in the art, and will be understood to allow implementation in other alternative technologies without diminishing the effect of present invention.

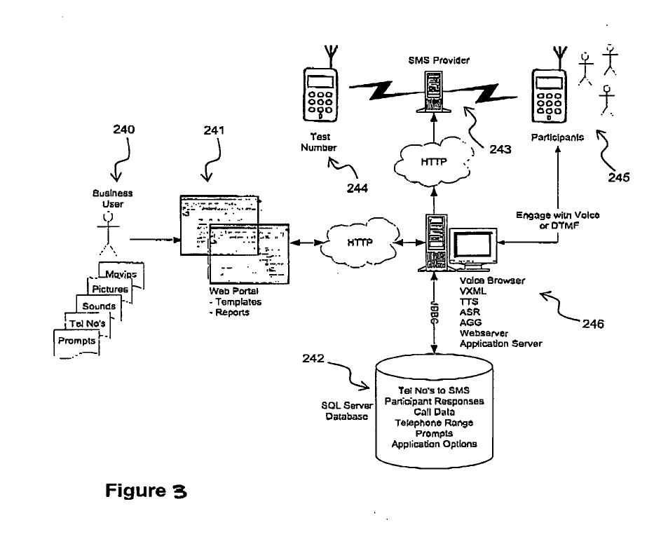

FIG. 3 schematically shows the architecture of a system. The system operates according to the following method:
1. User 240 enters their information via an HTML page 241 over the Internet. The pages are generated using JSPs. These obtain information from and store information to a database 242 via a JDBC link from a Java Bean.
2. A test facility is available to send the campaign introduction SMS message 244. This uses a backend service (EJB) that is invoked by an HTTP request. This in turns uses HTTP to call a 3rd party SMS vendor 243 to send the test SMS. A daemon (Java client) is also set-up that checks to see if the distribution time for any SMS campaign has been reached and when it is, it sends an SMS to all the numbers that were imported and stored in the database for that campaign, in the same way as it does for the single test.
3. The HTML interface 241 contains auto-completion and default value functionality to aid with the efficient and accurate creation of campaigns. For example a quiz will require questions to have answers, and an optional instant-death prompt whereas a vote will not. These constitute a template that is dynamically updated based on which options the user selects, allowing the minimum amount of dynamic information to be entered, and enforcing that best practice is implemented for the final voice user interface.
4. On submitting this information, the next available telephone number from a range is allocated to the campaign.
5. All telephone numbers are pre-assigned to an active Voice Browser.
6. When called by a participant 245, the first available VWS instance assigned to that number runs a VXML application, the VXML being generated by JSPs 246.
7. The Voice Browser instance, acting on the VXML calls a backend service passing through the dialled number. The backend service (Enterprise Java Beans) then interrogates the database 242, via a JDBC link to determine which campaign is active on that number, and passes back the campaigns data in JavaScript object format.
8. The appropriate TTS voice for the campaign is selected.
9. The appropriate ASR language for the campaign is selected 246.
10. The prompt text for the language selected is loaded up.
11. If the campaign is not yet active or has finished, the appropriate message is played and the caller disconnected.
12. The Voice Browser continues with the voice application playing the appropriate static and dynamic content as required. The call flow logic for the application is held within JavaScript objects and carried out using JavaScript methods.
13. The users answers are stored as the VXML 246 is executed within a JavaScript result object.
14. The logging statements such as call begin time, call duration, question confidence, misrecognition counts and ambiguity detection are stored within a JavaScript logging object. These can be reported on to discover possible problems with the voice user interface as early as possible.
15. When a recognition result is required, a grammar or language model is produced by the Automated Grammar Generator (AGG) module 246 (Enterprise Java Beans). The input to AGG comprises appropriately formatted information on the current context which can be referred to by the user in this case the question and possible responses. The AGG module returns grammar(s) or language model(s) (possibly incorporating one or more grammars) for the recognition. In addition, a natural language understanding model is generated which interprets natural language utterances and maps them to a semantic representation used internally in the spoken language interface.
16. An N-Best list of results is analysed to determine the degree of possible ambiguity for the answer, and if this is above a certain threshold, a disambiguation strategy is invoked, for example using more directed dialogue or DTMF (telephone keytones) 245.
17. If there is not enough agreement between the model and the answer (nomatch) or there is no input, an escalating system of prompts (again allowing DTMF) is invoked to obtain the answer from the user.
18. In one embodiment a tiebreaker allows the user to record an utterance for later retrieval. This is stored onto the file system by the Voice Browser instance.
19. Once the call is complete or the user has hung-up, the backend is called again to store the results of the call, into the database 242. This is done after the call is disconnected to avoid latency, but the invention is not restricted to this embodiment. The system will enumerate through the reporting and logging objects saving their data to the database so it can subsequently be queried and reported on.
20. The reporting screens 241 are available to summarise the data saved for all the calls including randomly choosing a campaign winner, and reviewing the users tiebreakers. This uses JSPs connecting through JDBC to the database so the information is current as soon as the call has finished and its data saved.

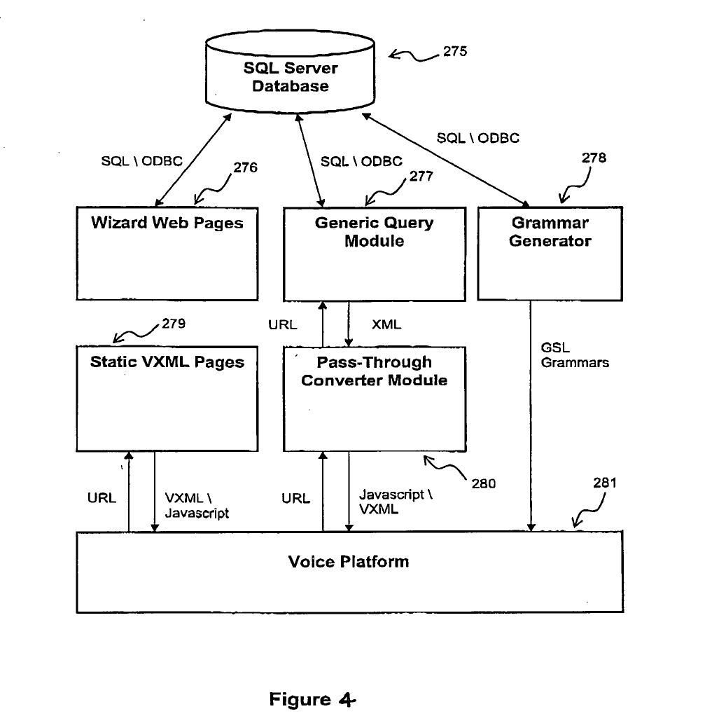

FIG. 4 shows an architectural illustration for providing embodiments of the invention. FIG. 4 shows an architecture that is suitable for executing a wizard to enable a user to create customised speech interfaces, for example, when the architecture is physically implemented using a computer-based system. Accordingly, the following description relating to FIG. 4 relates to a wizard used to customise a speech interface for a software-based quiz application, although those skilled in the art will realise that other implementations would also be possible based upon this architecture.

A SQL (Structured Query Language) Server Database 275 stores the user entries from the Wizard Web Pages 276 specifying the speech application, setting the type of application, questions, answers and other text elements. This allows the user to retrieve and modify the application specification. The actual type of database may be implemented through different systems, such as Oracle. The communication mechanism used for storage and editing of web page 276 content with reference to the data base currently uses Java Server Pages (JSP) but may also be implemented by alternative methods such as ASP, etc.

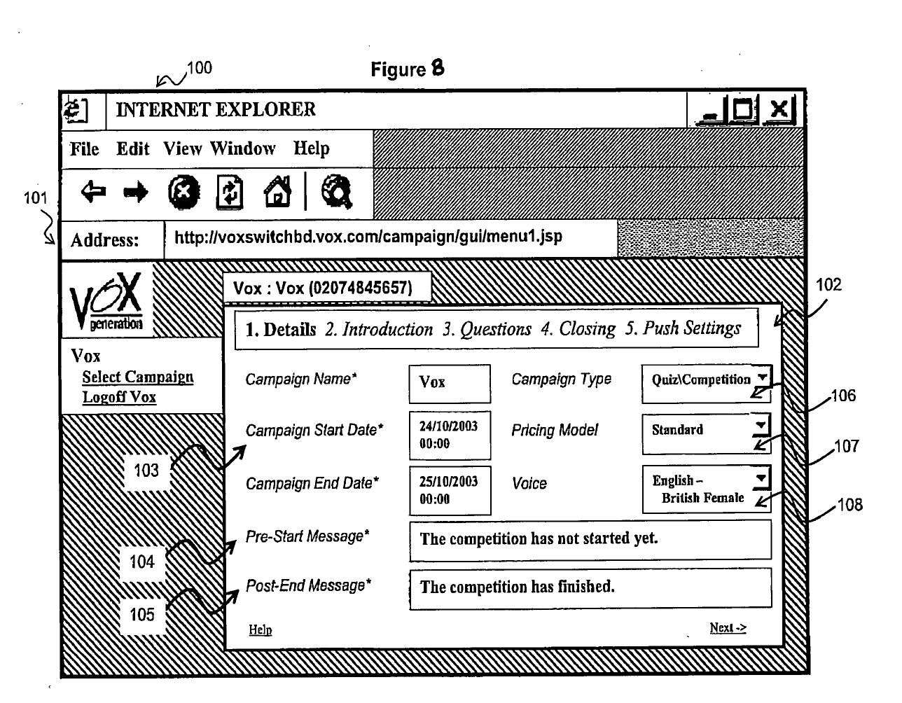

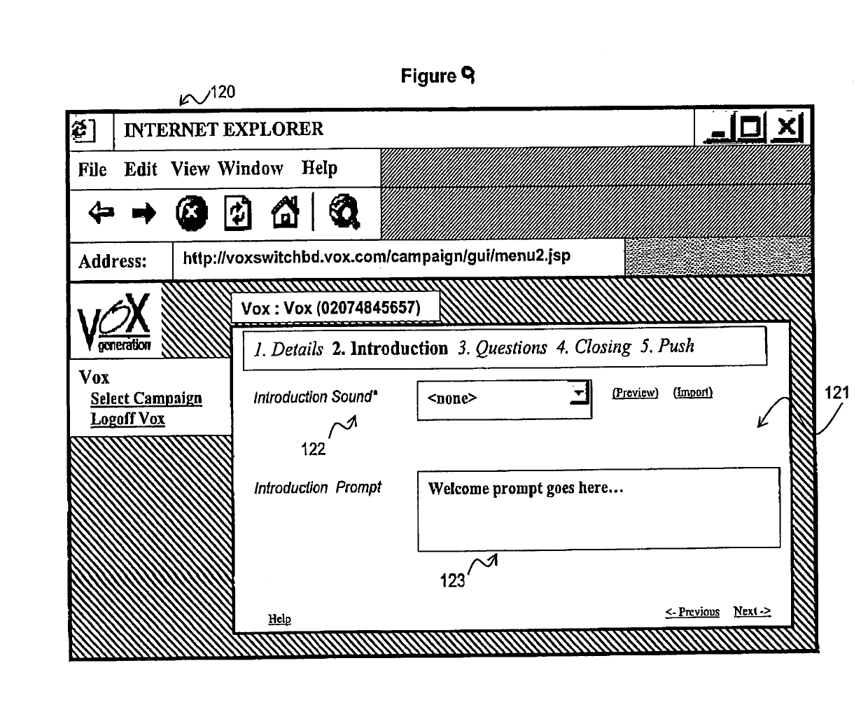

The Speech Wizard Web Pages 276 are a series of Java Server Pages (JSP) front-end screens, presenting template forms and allowing user input. Examples of such screens are illustrated below in connection with FIGS. 8 to 12. The screens are managed by a web server which makes dynamic connections to the SQL Server Database 275 for storage and update of user content from the web pages. Each campaign or application is tagged with the number dialled (DNIS) which is used to uniquely identify each application and direct the system to activate the appropriate application based on the telephone number tag. Each campaign/quiz is assigned a number to call it on, and by recognising this number that callers call in TO (rather than the CLI of the caller themselves which is the number they call FROM) we can determine which campaign\quiz they are trying to call, and get the data for that specific one.

Now we consider the connection between the Wizard Web Pages 276 and the SQL Server Database 275. We have a front-end screen presentation for user access, served by a JSP web server, for example introduction.jsp, that opens a connection to the database using standard ODBC and sends a query such as:
“select intro_prompt from campaign”.

The recordset that the SQL server database 275 passes back contains the introductory prompt, and this is displayed in the HTML web pages 276 that the JSP produces.

VXML is the format used to describe speech system dialogue. The VXML content runs in the voice platform 281, and when the static VXML pages 279 require data, it redirects the voice platform to a URL which points to the Pass-Through Converter Module 280 such as the following example URL:
<goto next=“pass_through.jsp?action=get_campaign&dnis=1234”/>

The voice platform 281 then tries to get the output of that resource and importantly, it is expecting VXML. In various embodiments, part of the function of static VXML or HTML forms is to provide the necessary templates as desired.

The Pass-Through Converter Module 280 receives a request from the VXML platform, and needs to get some data to fulfil the request. To make the system implementation as generic as possible, the input for the Pass-Through Module is XML formatted data from a URL. Due to this generic feature a separate modular component is connected, which serves the function of query and retrieval of data from the SQL Server Database 276, and is shown as the Generic Query Module 277. This module is responsible for providing data as XML. To illustrate this function with an example, the Pass-Through Module 280 calls:
generic_query.asp?action=get_campaign&dnis=1234

When Generic Query 277 gets this request, it runs the query associated with the action “get_campaign” on the database using ODBC. e.g.
select * from campaign where dnis=1234

The SQL Server Database 275 returns this to Generic Query 277 as a recordset, which Generic Query 277 then loops through and produces a string of XML e.g.

<?xml version=“1.0”?>
<campaign >
<intro_prompt>Hello</intro_prompt>
</campaign>

When the Pass-Through Module 280 receives this XML, it analyses it using a standard Java XML analyser called a jaxp parser, and reformats it into the VXML that the voice platform 281 is looking for, e.g.:

```
<?xml version=“1.0”?>
<vxml>
<form>
    <block>
        <var name=“intro_prompt” expr=“Hello”/>
        <return namelist=“intro_prompt”/>
    </block>
</form>
</vxml>
```

And when the VXML platform 281 receives this VXML, it passes the variable, intro_prompt back to the static VXML pages 279 for it to play to the user.

When the static VXML requires a grammar, it directs the voice platform to get the grammar from the Grammar Generator 278 with a URL e.g.
grammar_generator.jsp?campaign=1&question=2

The Grammar Generator 278 will then go to the SQL Server Database 275 using an ODBC with a query such as:
“select * from campaign_answers where campaign=1and question=2”

It then parses the recordset that is returned to produce a GSL (or other grammar format, such as GRXML) document such as below, which is then returned to the Voice Browser, VWS, or Voice Platform 281 to be used in speech recognition:

| ANSWER [ | |
|---|---|
| canberra | {<answer=1>} |
| melbourne | {<answer=2>} |
| sydney | {<answer=3>} |
| ] | |

Once the application is executed, the generic query module 277 (implemented as a JSP) runs an SQL query on the database 275 to extract information that the user has placed in the forms specifying the application. The generic query module then produces a processed and formatted version of that information as XML data structures.

The Speech Wizard uses a mixture of static and dynamic Voice-XML (VXML) data structures and methods, although other platforms such as the Microsoft™ SALT Browser could be used. The Voice Platform 281 retrieves the appropriate Static VXML Pages 279 through URL reference. The static VXML page 279 sends a request via the Voice Platform 281 to transfer to a completely new VXML page containing JavaScript (generated by the Pass-Through Converter Module 280), and when that finishes its execution, it returns the variable back to the static pages. The static VXML pages include static JavaScript components.

The Pass-Through Converter Module 280 is at the heart of the speech wizard. This processing element converts generic XML into a VXML page with only a JavaScript object containing all the data. The Pass-Through module is referenced by URL (Uniform Resource Locator) from the Voice Platform 281, including the called telephone number (DNIS). The Pass-Through module then further references the generic query module 277, which passes the DNIS as part of a select statement to the SQL database.

The Pass-Through Converter Module 280 processes, formats and generates the JavaScript and VXML suitable for execution by the Voice Platform 281. A number of calls are made to the Pass-Through Converter Module 280 for the various data components during processing. In particular the first call sends the DNIS through to obtain the campaign data including campaign_id. The Pass-Through Converter Module 280 is then called again with the campaign_id to obtain all the questions, and finally is called a third time to obtain all the answers.

The SQL Server Database 275 does not store the full grammar and grammar variation rules for the application. These grammars are generated dynamically right at the moment the caller is expected to speak during each phase of the speech application session by the Grammar Generator 278. The text elements specified by the user in the web pages 276 are dynamically processed to form an appropriate set of grammar rules formatted as GSL Grammars for the Voice Platform 281.

The Deployment and Scheduling operations are performed as other data items, stored in the SQL Server Database 275. The current time and stored time are compared using the Static/Dynamic VXML page reference system, where appropriate text for before and after the operational period are played.

Once each caller has finished, the Pass-Through Converter Module 280 is responsible for processing details of the dialogues, answers and choices back to the SQL Server Database 275. This data is then available for further query and reporting operations, including presenting graphical reports to the user in the form of additional web pages.

Alerts and outgoing messages are specified from the user web pages and are sent to an SMS provider and/or email generation from the JSP pages on the web server.

The over-all timing and flow of information through the speech wizard is event-driven, with principle events being the creation or editing of information in the Wizard Web Pages 276, storing this information in the data base, then once operational (deployed), the events of callers using the speech application and moving through the various dialogues.

The design and architecture of the speech wizard includes various trade-offs between flexibility and application performance. The wizard architecture uses a certain amount of expert-defined static structures and/or rules, and then allows user-defined flexibility within certain constraints. The result is an application that when deployed performs well, has high recognition rates, etc., without requiring any hand adjustments by a speech expert. It allows enough flexibility to cover a wide range of application styles and content, without forcing the user to adopt restrictive templates. For example, even if the user defines three answers that are very similar (as they are advised not to in the help system), which often leads to two or more answers given by a caller being deemed to be recognised with confidences too close to each other, then the system will back off to dtmf (numbered touch tone) entry for the fields so an answer can still be obtained.

Various other wizard-based implementations have also been envisaged by the applicant and there are a number of benefits and disadvantages for each which were weighed up when selecting the architecture of FIG. 4. For example, once data is entered into the system, a wizard may be configured to automatically generate a complete static VXML page, which is then run in the Voice Platform. Alternatively the VXML pages could be completely JSPs that go to the database when called and format themselves based on the data into a complete VXML document. The grammars could also be automatically generated as static grammar files soon as the answers are entered into the Wizard Screens. The overall outcome for the users and callers of using these alternative architectures will probably be unnoticeable. However, from the system point of view, the architecture of FIG. 4 does provide advantages in terms of speed of development, ease of maintainability and enhancement, and pre-caching speed.

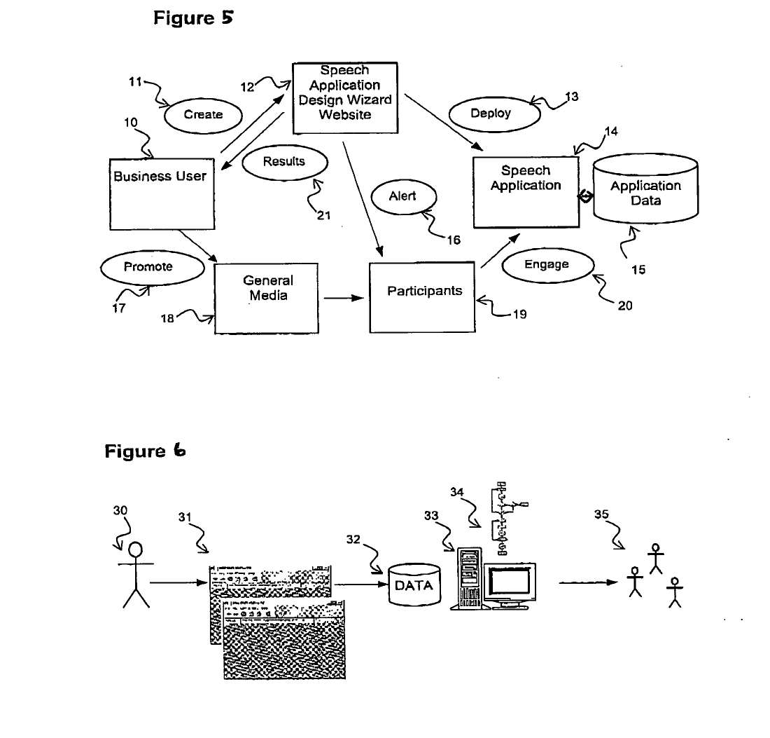

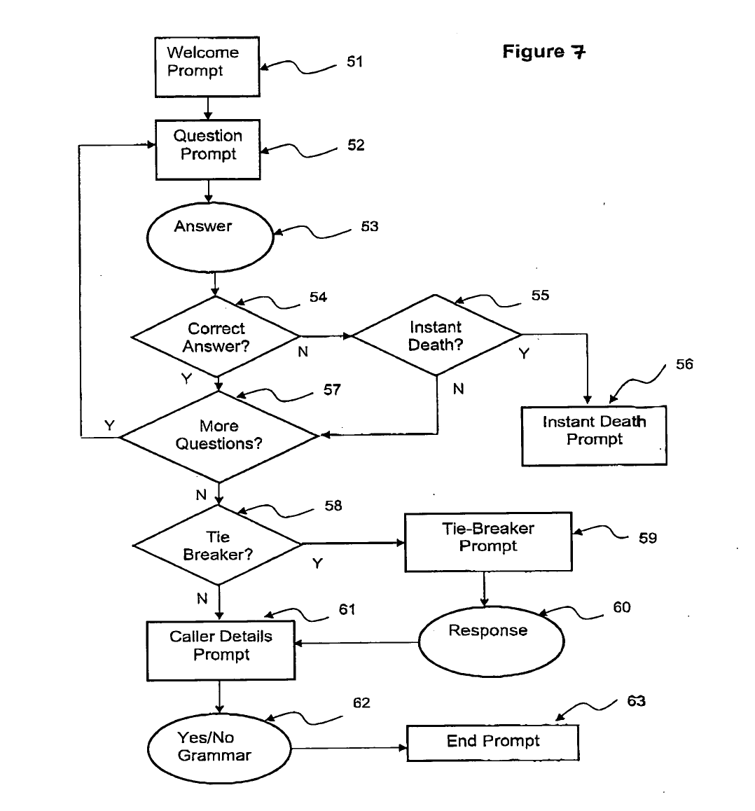

FIG. 5 is a diagram showing the flow of operations from initial creation to full operation of a speech application including various method steps. The system schematically shows the steps involved in the present invention, forming a closed loop sequence for the non-expert user to fully manage operational aspects of a speech application, intended for communications directed to participants via mobile, satellite, or landline telephone.

A user 10 manages a speech application 14. The user 10 initiates such management by a creation operation 11 where creation operations are carried out using a speech application management user interface, such as by example a web wizard, web pages, a stand-alone application, or web portal 12. During the creation phase 11 the user 10 may choose an application type, set the start and end times, set questions and answers, upload jingles, alert SMS phone numbers, determine the voice characteristics, give directions for handling other media (such as graphics or video) and set the call tariffs to be used.

Once the characteristics of the speech application are established using the design wizard 12, the speech application is deployed 13 to a suitable speech application server 14. The speech application server 14 becomes active at a pre-set time, and may optionally send alerts 16 to potential participants using application data stored for the purpose 15, established prior to activation by various means, suitably by the user 10 uploading such data.

At the pre-set time, alerts 16 are sent to participants 19 using scheduled electronic messaging such as SMS text messages, email, fax, etc. Coincident or otherwise with the activation time of the speech application, the user 10 may also promote 17 and encourage potential responses to participants 19 by the use of general media 18 such as TV, radio, newspapers, advertisements or web broadcasts.

In response to such alerts 16 and promotion 17, one or more participant engages 20 with the speech application by initiating a call to the speech application server 14. During this engagement, the participant 20 communicates with the server using spoken language dialogues.

During and after the active period of the speech application operation and participant responses, a result reporting 21 phase is included whereby the user 10 may gather information about the statistics of various aspects of the speech application and optionally including response details of individual participants 19. Further, the user 10 may elect to modify the Speech Application 14 at any time before or during the active period of the speech application using the Speech Application Design Wizard 12.

FIG. 6 illustrates a high level functional flow diagram. Users 30 enter all the details of their application on the web wizard, web portal or application configuration tool menus 31. These details include specifying the prompt speech messages, jingles, questions, answers, votes, survey details, start and end dates, push alert numbers, voice style, interactions with other media, voice characteristics, etc.

The details are downloaded to a speech application server 33, including application specific data such as jingles and alert numbers which may be stored in a database 32. The details are then processed and a complete speech application is configured automatically to implement the chosen speech application. The configuration process establishes a set of rules, grammars and call flow 34 that each participant 35 will follow on each call. The campaign may be used straight away or at a pre-set time when activation is automatically scheduled on the speech application server 33. The speech application is used by one or more participants 35.

FIG. 7 provides a flow diagram for a particular example speech application suitable for a simple quiz interaction with a participant. Such a call flow is derived from a template tailored by a user using the design wizard discussed above and established during the deployment phase. It sets out the style of interaction that each participant will experience when engaging or responding by calling the speech application server.

At the start of a participant call is the welcome message 51 to be played to participants. This can include an opening sound, such as a jingle, that will be played before the welcome message. In the next step a quiz/competition questions, votes, survey, training questions etc. is asked by the system 52. This prompt 52 encourages an appropriate response from the participant will be prompted to provide a response 53, such as an answer to a question. The participants response is then received 53. If required a different path can be taken by the system if the participants answer is correct or incorrect 54.

In this embodiment, if a participant gets a question wrong in an ‘Instant Death’ scenario the participant will not be allowed to continue 55. In other embodiments a variety of alternative paths can be generated and these would be derived from the template specific to that embodiment. A special message is played to the participant in an ‘Instant Death’ scenario 56. The application checks if there are any more questions to be asked 57.

In this embodiment the application will check if a tiebreaker question has been specified as part of the speech application by the designer 58. The tiebreaker question is presented to the caller 59. The participant's response to the tiebreaker is accepted 60. In this embodiment a request is made for the caller details 61, in case of follow up. The application then listens for response to request for caller details 62. A closing message is played to the participant 63, where this closing prompt can include a sound, such as a jingle, that will be played after the closing message.

FIG. 8 is an illustration of an embodiment of a graphical user interface as part of the web wizard used by a user to create an instance of a speech application. The user interface is presented, by example and as illustrated, using a world-wide-web browser, such as but not limited to Microsoft Internet Explorer™ 100.

The web-wizard graphical user interface is available from the web browser by accessing a web portal site, having an HTTP or HTTPS type of URL address 101. Within the browser windows appear the content of the web wizard website interactive pages 102, where, as illustrated the web wizard starts with a page for entering campaign details 102.

Various input fields are presented to the user for establishing speech application details, such as the start and end date 103, the pre-start message to be played to users who call before the active period, the post-end message 105 to be played to users who call after the active period has ended, the campaign type 106, where various application templates are selected as a general framework, the pricing model 107 where various premium, standard, or other call charging options for the tariff model to be applied to all calls during the active period, and finally voice character options 108 to specify the attributes of the automatic text-to-speech (TTS) mechanism used to present prompts or other information to the participant.

FIG. 9 is a further illustration of an embodiment of a graphical user interface as part of the web wizard used by a user to create an instance of a speech application. The user interface is presented as a web-wizard user interface in a web browser 120.

Within the browser windows appear further speech application specification pages for entering introductory aspects of campaign 121. Various input fields are presented to the user for establishing further speech application details, such as any optional sounds, music, jingles, multi-media content to be played or displayed during the introduction phase of the application 122. Within the introduction menu, an input text field allows the user to specify the introduction prompt speech output 123.

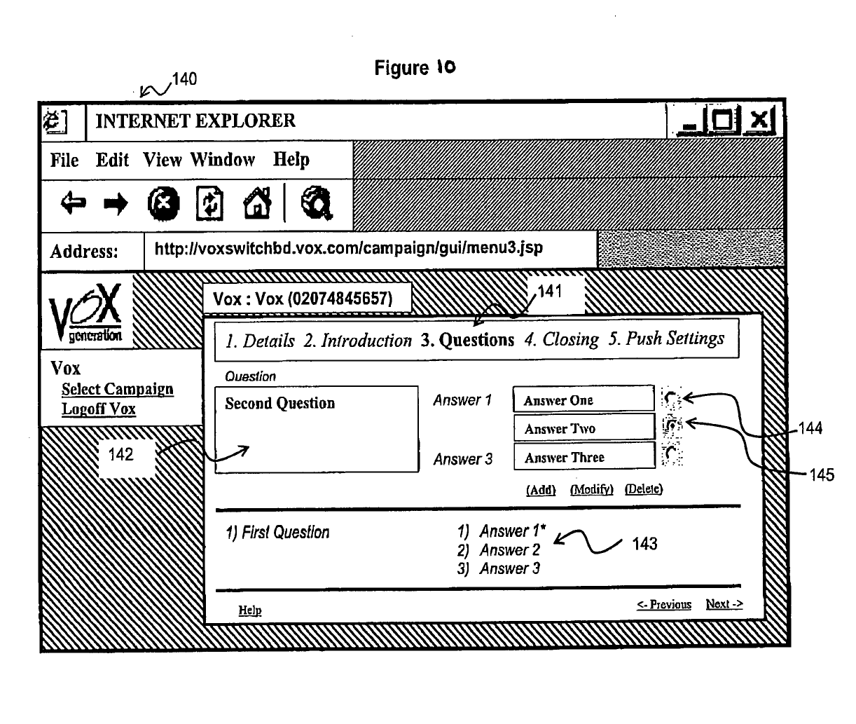

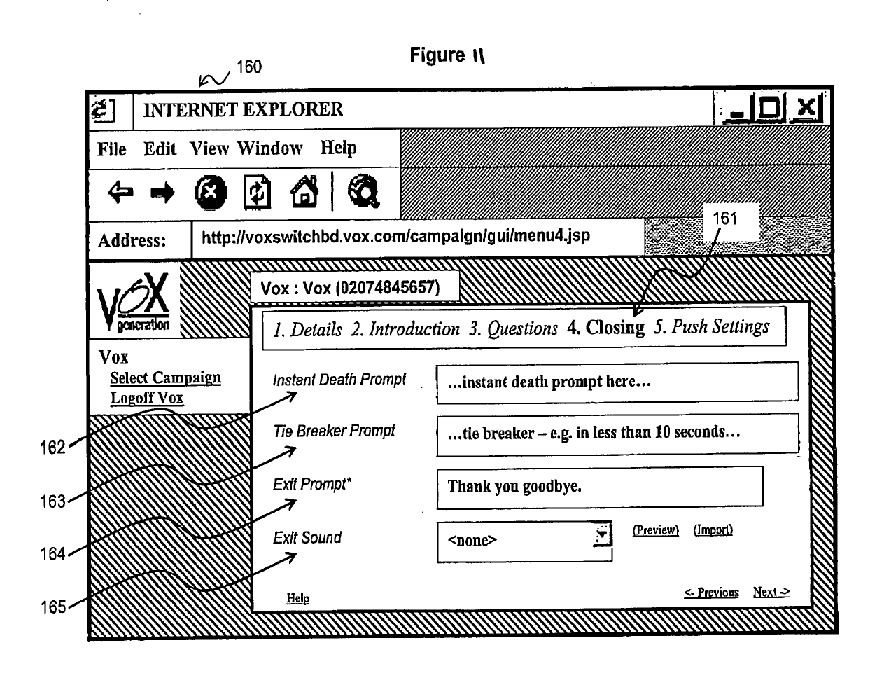

FIG. 10 is a further illustration of an embodiment of a graphical user interface as part of the web wizard used by a user to create an instance of a speech application. The user interface is presented as a web-wizard user interface in a web browser 140. Within the browser windows appear further speech application specification pages for entering question aspects of, in this embodiment a marketing campaign 141, where it has been configured to a quiz style of application. Various input fields are presented to the user for establishing speech application details, such as the series of question prompts 142. Each question has associated possible answers, in multiple-choice formats, specified along with the question 144. One particular answer is marked as the correct answer 145. For a reference aide to the user, all the questions, apart from the one currently being entered, are shown in the menu panel 143. Menu controls allow a user to create new questions, modify existing questions, or delete questions.

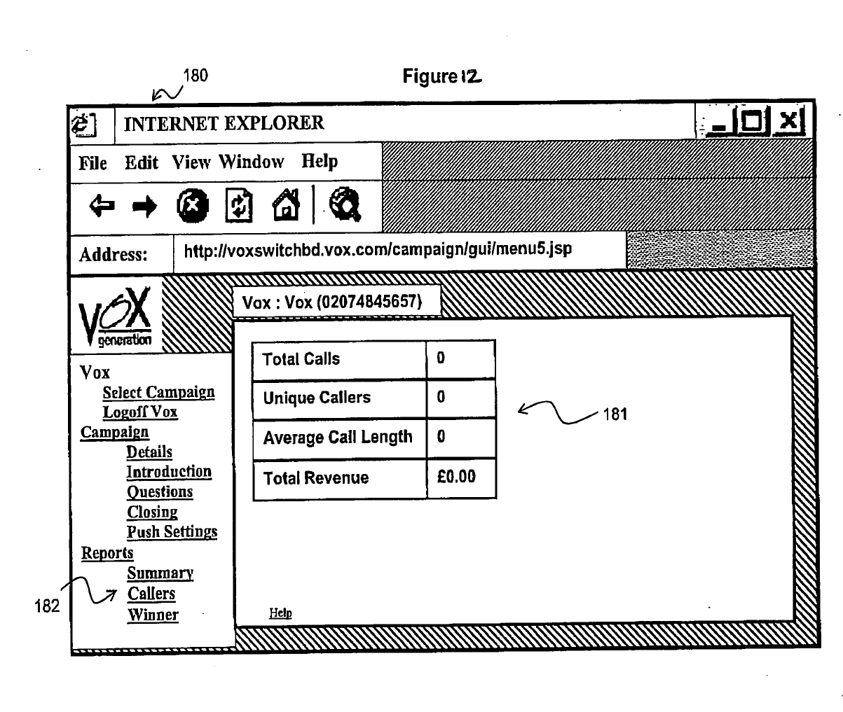

FIG. 11 is a further illustration of an embodiment of a graphical user interface as part of the web wizard used by a user to create an instance of a speech application. The user interface is presented as a web-wizard user interface in a web browser 160.

Within the browser windows appear further speech application specification pages for entering closing aspects of campaign 161. Various input fields are presented to the user for establishing further speech application details, such as an instant death prompt 162, a tie breaker prompt 164, and exit prompt 164, and an optional exit sound sample to play 165.

FIG. 12 is a further illustration of an embodiment of a graphical user interface as part of the web wizard used by a user to create an instance of a speech application. The user interface is presented as a web-wizard user interface in a web browser 180.

Within the browser windows appear further speech application pages for reviewing the live status of campaign or closing consolidated results and statistics 181. Here statistical data such as the total number of calls, the number of unique callers, the average call length and the total revenue generated are shown to the user. The application also provides for reviewing details of each caller and further menus for the review and selection of winners 182. Reporting information may also be sent to users or other interested parties using other message paths such as email, SMS, fax, etc.

Various embodiments of the invention can be used by non-experts for the development and subsequent use of speech-enabled applications. For example, users or authors, like business users, for example, can use various embodiments for the deployment and management of push and response management schemes, such as might be used for marketing campaigns and surveys. Using Automatic Speech Recognition (ASR), a closed-loop set of method procedures and processes allow a non-expert to, for example, specify, deploy and manage a marketing campaign involving electronic push messaging, interactive spoken language interfaces, Web-based wizard for campaign creation, management and reporting etc.

Various parts of the system are commercially available. Conventional attempts have focused on an expert bringing together collections of sub-components to aid or speed the development or prototyping phase of speech application development. Web interfaces for automating campaigns involving both Short Message System (SMS) push and SMS response to mobile phone participants suitable for non-expert users are known, but have not attempted to include automatic speech recognition due to the complexity of integrating speech application components. Furthermore, prior interfaces do not generally allow the integration of different communication channels and media such as speech, graphics, text, touch, keypads, pointing devices and sound.

In certain embodiments, the present invention overcomes limitations of existing methods by providing a closed-loop complete solution for managing speech applications. Currently, voice response is often routed to call centres which are expensive and not fully automated, relying on human operators to cover non-automated portions of a voice response. It is advantageous to reduce call centre operator time due to cost and the problems of rapidly responding to increased capacity demands. Traditional Interactive Voice Response (IVR) is frustrating to use for many participants as it involves the use of tones, inflexible fixed menus, fixed interaction dialogues and limited or no grammar processing. Automated speech applications are normally very complex and time consuming to design, build and set up, needing experts in the fields of automated speech recognition (ASR), grammar design, language modelling, voice user interface design and natural language speech processing. Those speech application automation design software tools which exist are either very complex or if they do offer a user-friendly aspect, they are not actually controlling a natural, spoken language end-to-end automated system or still require expert designers and builders.

It is anticipated that the present invention will make it quicker and less expensive for users, such as businesses, to deploy and run speech applications. The ability to build speech applications need not be controlled by a small number of speech technology experts. The complexities of building speech applications that are accurate, reliable and robust are hidden from the non-expert user and handled through a combination of wizard creation tool and specialised software components that use the output of the wizard to generate the complex speech and other necessary components, and make them ready for use (deployment). There does not appear to be an effective alternative to this invention, other solutions would involve integrating multiple systems from other vendors, or major extensions to existing systems, or using speech experts and software developers designing from scratch or bringing together lower level speech application sub-components. It is anticipated therefore that this invention will bring advantages to business customers. These advantages include the ability to be used directly by business customers for whom the ability to self-build and manage speech applications offers revenue generation opportunities, faster time to market, more flexibility, productivity savings and opens up this technology for uses such as information dissemination. Previously these business customers have been excluded from exploiting speech technology due to cost, the shortage of experts and concerns over the performance of speech applications. By using a system implementing this invention they will be able to directly control this aspect of their business.

Typically it may take a team of speech and software experts at least six to eight weeks to build and deploy a speech application of the nature of the example embodiments discussed here. This invention as described can allow a non-expert with minimal training to “self-build”, or create and deploy the same application in as little as five minutes.

The anticipated application and practical use of the present invention include a number of commercial business and public service activities. These include but are not limited to marketing campaigns for products or services, phone in competitions, polls, surveys, and voting scenarios, public service or charity marketing campaigns, phone based interactive training, call-flow scripting, utility company emergency alert and response, public health or security alert and response, sales force automation (SFA), customer relationship management (CRM), call centre screening, or interactive art, music, drama or literature projects.

The whole system from speech application design and authoring to post-analysis reporting may be made fully automated and closed loop. When the application author has used the Web Interface Wizard (or other graphical user interface embodiment) to create the speech application, the system generates all the requisite components and handles deploying, starting and ending the speech application including messages for the system to play before the application is available to participants and users and after is has stopped being available. The speech application generated by the system allows for users to use natural language responses and adapts its dialogue strategy according to the nature of each interaction, for example if a user is having difficulty the system will automatically move towards a more constrained or directed dialogue technique even utilising IVR (touch-tones) if appropriate. It also allows for sound files or other media to be uploaded and played or displayed by the system at specified times and other events to be triggered by the system such as emails, SMS, faxes, database updates, ring-backs, graphic downloads. Although the core method is focused on speech applications, it may also optionally include any other communication media in a co-ordinated and complimentary manner.

Various embodiments relate to a method loop consisting of (1) Speech application server deployment, and (2) Participant response using a Spoken Language Interface (SLI). To add clarification, this method loop involves deploying and activating a speech application on a speech application server suitably connected to telecommunication networks and services enabled to receive participant calls. When participants make a response by calling, the resulting dialogue uses automatically generated speech output prompts, live vocal responses by the participant and processing of those responses by an automatic spoken language system. Suitably, the speech application server deployment utilises a template specification with attributes setting out specific fields within the template. Example embodiments are herein described to explain such templates and fields.

The speech application is established using one or more templates. The template serves the purpose of establishing the configuration and content of the speech application and associated systems, with some parts of the speech application specified by the template and other parts open for user choice. The template may be considered to have information “slots”, where some slots are predefined and other slots are set by a user through a graphical user interface. The templates are designed to establish speech applications that allow user configuration by a non-expert user, perhaps for the first time, enforcing best practice. The character of such templates vary from simple, where the majority of speech configuration and other content is predefined, through to flexible configuration choices, made available to, for example, a more experienced user. The flexibility enabled by the template is supported by suitable speech application components, where such components are able to operate reliably within the constraints of the template. The use of templates in this way is enhanced by the availability within the system of automatic processes for generating the speech application and associated multi-modal components (multi-modal being the characteristic of a system to allow inbound and outbound communication collaboratively through a number of different complimentary channels, such as but not limited to voice, sound, visual, tactical and sensory). These automatic processes combine the standard constructs held within the template (such as prompts, grammars and dialogue flows) with those inputted by the user. These automatic processes encompass offline or online processes. That is to say they can be run while the application is active or when it is inactive, for example, as part of the generation process. For the purpose of this invention these automatic processes should not be restricted to those listed here, but any which support the method whereby business users or other non-experts are able to build and deploy speech and multi-modal applications through the use of a web wizard and templates.

By way of example such automatic processes could include automatic grammar generation (AGG) optionally using AL processing (e.g. as described in the applicant's International Patent Application WO-A1-02/089113, the contents of which are hereby incorporated herein in their entirety), automatic Text-to-Speech (TTS) prompt sculpturing, non-directed dialogue processing optionally using AL processing (e.g. as described in the applicant's International Patent Application WO-A1-02/069320, the contents of which are hereby incorporated herein in their entirety), enhancing and tuning, grammar coverage tools, tools that disambiguate using multiple information sources, automatic generation and preparation of other media and multi-modal content in support of the speech application such as but not limited to graphics, sounds, video clips.

The above method can be augmented by an optional outgoing messaging step using traditional general media promotion and/or electronic media alerts such as SMS text to participant mobile phones. To add clarification, this augmented method loop involves deploying and activating a speech application on a suitable server. The speech application server then generates alert messages sent out to potential participants, using a form of electronic communication, suitably by SMS text messages. This may optionally be substituted with or enhanced by the use of traditional media promotion. When participants respond, the voice response is processed using an interactive automated spoken language interface, using natural dialogue.

The loop involving the above three steps can then be further augmented by adding an initial design step, such that it consists of (1) Speech Application Design and Management for non expert users, (2) Speech Application Server Deployment (3) Push Alert Messaging (4) Participant Response.

Supplemental system operations may extend this set of steps to include a web wizard or other graphical interface, web or other graphical result reporting, using both push alerts and traditional media promotion. Adding such operations allows the process to be controllable by non-expert users. With these supplemental steps the complete system may therefore consist of (1) Non-expert use of Web-Wizard to author, specify and manage the speech application, (2) Speech Application Deployment, (3) Push Alert Messaging, (4) Co-ordination with other general media promotional messaging, (5) Participant Response using SLI dialogues, and (6) Reporting of operational and consolidated results.

As an example of a customisation process, the non-expert user can access a web wizard user interface to design and specify the characteristics of the speech application by selecting from a set of application specific templates (e.g. competition, voting, quiz, survey, poll, questionnaire, interactive training, etc). Once the template has been filled in, the speech application is deployed on the speech application server and associated systems. To coincide with the scheduled activation, traditional media promotion can be used. At scheduled times, SMS text messages are sent to selected participants using data stored in a database and previously uploaded or otherwise integrated by the non expert user. The SMS text messages are alerts, urging potential participants to respond by calling the speech application server. When participants (i.e. application/system users) respond, they are greeted with automated speech content as specified by the user during the design phase. Spoken responses are processed using natural language automatic speech recognition systems. Both during the period of speech application activation and when finished, reporting is available to the user through the web wizard user interface. Reports may further be automatically sent by electronic means to staff involved in the speech application process.

In various embodiments there is provided a graphical user interface designed to be accessible for non-expert users, where a complete speech application may be specified, deployed, managed, and reported. Such a user interface may, in general, be an application presenting menus and providing control over the speech application configuration and options. These embodiments comprise a method and system for implementing the method where speech applications are established and managed, suitably using a web-wizard or other graphical interface for non-experts. The web-wizard may be supplied in a generic form to a number of businesses, or may be tailored to the needs of an individual business, such as by including custom content and branding for that business. Such an interface is designed to allow closed-loop, end-to-end automation management. The method and systems implementing the method provide easy-to-use templates for specific applications. Typical intended use of these templates in, for example, marketing campaigns include telephone-based competitions, voting or surveys, interactive telephone based training in a question answer format, call flow management and any “self-build” speech application. These templates contain the bulk of the system prompts and responses, the general structure of the speech application, the dialogue structures and form of the web wizard. It should be noted that the management interface allows changes and modifications to the application both before and during the speech application activation period and is not restricted to use before deployment. The web wizard format of a graphical user interface further implies the use of distributed computing, where a web server supplies graphical pages and a client, normally a web browser application, provides the user with a view of said pages. The client system to view said pages may be any interactive platform suitably configured, including a PC, personal digital assistant (PDA), mobile phone, or in fact be co-located with the source of the pages on the same platform. The client may be a thin client.

In various embodiments, one or more participants may be involved in receiving push messages or responding to such messages. This is an optional aspect, since participants may seek out involvement and respond without any direct push messages in some applications. Suitably, as implemented in the applicant's system, push messages are included as an aspect of the user controlled speech application. Participants may choose to respond as a result of a particular alert message, or for any other reason. Participant response may or may not be conditional on having received an alert communication. In some applications a password or identifier may form part of the alert message and subsequent dialogue. Such password or identifier may then be used to authenticate the participant or establish a logical relationship between the push alert and the participant response.

In various embodiments, the speech applications so established and managed may optionally include push alerts and notifications sent to participants and potential users. The communication channel used for such push alerts could, by way of example, use Short Message System (SMS) protocols or similar electronic pathways (including but not limited to EMAIL and FAX), participants or users respond through a spoken language interface (SLI). For participant groups using mobile phones, the alert messages are can use SMS. For demographic groups not as comfortable receiving SMS, or without such a facility such as with landline telephones, then text-to-speech (TTS) technology alerts may be sent as automatic outgoing voice calls. The participant groups receiving push messages by automatic electronic means will suitably involve participant details stored in a database.

In various embodiments, the user may also optionally involve promotion to encourage participant response. Such promotion is generally co-ordinated and scheduled to correspond with the timing of the speech application activation period. Such promotion generally involves the use of traditional media channels such as TV, radio, newspapers, hoardings (billboards), bumper-stickers, posters, leaflets, direct post (mail), website, magazine inserts, door-to-door, internal corporate announcements, or other advertisement methods. It should be noted that the message content as communicated in the push phase, either by promotion or directed alert messaging, may be supplemented by additional message content delivered at the time of the participant response, such as by voice prompts or informational dialogues. In the example of a quiz scenario, voice prompts may explain the quiz rules or prizes to greater detail than sent in the original alert or promotion. The choice of message content is completely available to the user to specify during the design phase and is not prescribed by the system architecture. It should be made clear that the present invention may involve a promotion step using general media, and electronic alert, or both.

In various embodiments, the user is provided with a mechanism to transfer data consisting of lists of participant details into the system, as part of the design and configuration phase which can then be used by the system for alert message destinations. Such data is generally proprietary and confidential to the user. Some form of outgoing push messages require participants to “opt-in”, avoiding unsolicited communications, involving a database or other electronic records held for the purpose of controlled message participant lists. For the purpose of clarity the term upload implies either uploading a file or other data source into the system at design time or linking the system to another system that holds and is able to supply this information to the speech system on demand or at predefined intervals.

In various embodiments, one or more speech applications may be managed and deployed by the same business. Such speech applications may be one-off special events or a series of speech applications may be scheduled and run in queued sequence or be run simultaneously. Such multiple speech applications may involve the same or distinct participant groups. Typically such simultaneous speech applications will involve both unique message content and largely unique participant groups: however this is not necessarily the case.

In various embodiments, one or more distinct businesses may access and use the facility for designing, deploying and managing speech applications at the same time, with secure and confidential content, thereby sharing the cost basis of the facility.

In various embodiments, an SLI need not be generated until run-time. Once the user finishes putting in the data for his application, it may be stored in a database. When a participant calls in, a static VXML application template can extract the bits of data it needs that are dynamic (via pass through). In the speech wizard, no VXML or grammars need be generated at application creation time, they may be formatted from the database data at run-time, and not themselves stored anywhere.

In various embodiments, a call flow (e.g. a series of VXML fields and blocks) need not be created. A static template may run itself based on data obtained from a database. The template may comprise a fixed set of static VXML elements, that JavaScript functions, operating on the data from the database call in the appropriate sequence. The static JavaScript and VXML may remain exactly the same for all applications, and only the configuration data on which it runs need change from application to application.

In various embodiments, the call data is only available after the participant has hung-up. In various other embodiments, the call data may be obtained and/or supplied in real-time to users or system users.

In various embodiments, as soon as a user finishes entering the configuration data, the application is available for use.

In various embodiments, the applications are initiated by an event-driven incident, such as a system user making a telephone call. The subsequent program flow, e.g. handled by the speech wizard from web user input or participant call flow, may however be procedural, e.g. ask a question, wait for a response to that question, ask the next question etc.

In various embodiments, design wizard does not itself tailor the call flow, but merely affects the variables used in the decisions within a predetermined call flow.

In various embodiments, nothing need be automatically generated when an administrator creates a campaign. It is only when someone calls in that the pre-written VXML application obtains the administrators data to fill in the dynamic parts and dynamically generate the spoken language interface (and it does this at run-time for every call). The grammar may also be generated this way: i.e. at run-time every time it is needed.

In various embodiments, the speech applications and associated design, configuration management and reporting systems may be hosted on an outsourced or contracted external organisation such as an application service provider (ASP), an in-sourced platform within the user organisation, or telecommunications operator hosted platform.

In various embodiments, operational monitoring and consolidated reports for the speech applications are made available via web or other graphical user interface (GUI) reporting. Suitably such reports are presented and included as part of the web-wizard user interface, where most aspects of the speech application are managed. Reports can also be automatically directed to managers or other designated persons using electronic media such as but not limited to email, SMS or Fax.

In various embodiments, the availability, readiness and capacity of the system can be co-ordinated with other external activities such as but not limited to general media advertising, corporate notices, customer notices. The readiness and responsiveness of the system may also be included in performance monitoring and thresholds scheduling options based on potential server loading, potentially to form the basis of service-level-agreements between the user and the application service provider.

In various embodiments, as an optional feature, revenue may be generated for a user by the use of the telephone call charging or Tariff model and other provisioning information selected by the wizard user, with call revenue reported. Such revenue could be shared with the ASP or other service provider.

In various embodiments, the methods and systems include facilities whereby the speech applications are multi-lingual and able to store, retrieve and publish speech applications in any user-determined language. Further, different language variants can be hosted on the same system and run at the same time. This is achieved by extending the templates provided to the web wizard to encompass new languages and through the provision of text-to-speech and speech recognition engines to support the additional languages by the service provider.

In various embodiments, the system implementing the method can be hosted anywhere, with access over any public or private data network. A possible configuration is where the user or speech application author uses a remote secure data communications facility, such as remote virtual private network (VPN) web access to outsourced service provider hosted platform.

In various embodiments, the speech application may be configured such that it allows not only control of the spoken language interface (SLI) but also other input and output channels (e.g. SMS, picture messaging, email, video, touch and pointing devices, gesture tracking, etc) for full multi-modality interaction control. For example, during a spoken language dialogue session a picture SMS sent to the mobile phone may include a photographic image used as part of the subject of the dialogue. A photo of a professional footballer could be sent to the participant, followed by a speech prompt such as “Identify this footballer; is it a) Name-1, b) Name-2”, etc. Multi-modality aspects may also involve downloading a new ring-tone to the participants' phone, etc. By using such multi-modal processing sound, visual and other channels may all be combined for use in collaborative information channels.

The user can design the required multi-modal application as he or she desires. Visual components can be selected and their properties set by the user. The timings and methods of presentation of components of the output modalities can be determined by the user. The user can also control the manner in which input modalities are used.

As an example to illustrate how this works, the designer/user might include an “X the ball” type question in a quiz that requires the end user to point to or mark where he thinks the ball should be located on a picture presented visually. In this case, the designer would select the picture to be used, specify its location on the screen and specify the area of acceptable answers by drawing a boundary circle on the picture where the ball should be. The designer would also include the text of the question to be read out and specify any sounds to be played. Timings for the presentation of these items can also be set by the user, as can appropriate timings for expected input.

Other input and output modalities can be included and controlled in a similar manner, for example, through touch devices (e.g. keyboards/keypads, mouse, touch pads/screens or other touch detectors, stylus or other tap, writing or drawing devices), through gesture devices (e.g. gesture capture devices, body-part position or movement capture, lip movement tracking, eye movement tracking, etc.).

In various embodiments, the speech application server and speech processing components are automatically configured to employ a dynamic automatic grammar generation (AGG) process. This process takes the items defining the current context (e.g. prompts, possible responses, and any other information provided by the user) and generates both a language model (LM) for recognition and a natural language understanding model (NLU) to interpret responses. The language model (LM), thus produced, may comprise a grammar, set of grammars, statistical language model, and/or any combination of these. The natural language understanding model (NLU) can be a grammar, set of grammars or a statistical language understanding model, and/or any combination of these. The language model (LM) and the natural language understanding model (NLU) can be combined in one model or applied in series to recognise and interpret responses. The language model (LM) and the natural language understanding model (NLU) can also be combined or used in conjunction with recognition and understanding models for any other input modalities, for example, through touch devices (e.g. keyboards/keypads, mouse, touch pads/screens or other touch detectors, stylus or other tap, writing or drawing devices), though gesture devices (e.g. gesture capture devices, body-part position or movement capture, lip movement tracking, eye movement tracking, etc.).

The descriptions of the items in the current context are analysed by the AGG component. The automated grammar generator identifies the types of natural expressions which can be used to refer to these items and produces grammars and language models which have the classes and rules and data required to enable recognition of natural language utterances. The text segments in the current context as defined by the user are modified both syntactically and morphologically and are then inserted in grammars and language models so that these items can be referenced using natural language utterances. A natural language understanding model is also constructed which maps utterances to a semantic representation that can be used internally in the spoken language interface.

Normally building such grammars, language models, or natural language understanding models is time consuming and requires a speech system expert. In the case of language models, a large quantity of data is required to train the models. By employing an automatic grammar generation component in the automated speech application deployment, the non-expert is able to build and deploy effective speech driven applications almost instantly. Since these grammars are included automatically in language models the final spoken language interface can recognise and interpret any natural language utterance. Since any words (or similar tokens, e.g. abbreviations, acronyms, SMS text elements, etc.) in the current context, the vocabulary is effectively unlimited and the user is free to include any expressions they wish.

In various embodiments, the speech application server includes a speech to text (TTS) output component which may be automatically configured to present spoken output in audible form in a variety of styles; for example male or female voices, local dialects, emphasis, mood, emotion or reference population. The voice styles are optionally pre-set according to a list of choices, where the user makes the choices at the time of speech application creation. The choices may be selected using any available electronic means to establish the configuration prior to the start of the speech application active time, this can be accomplished using a web wizard user interface. The invention may also provide the facility whereby the user or a ‘voice talent’ can call in to the system and records each of the prompts or alternately upload such prompts but recorded in a professional or other recording studio. In this event the TTS voice is replaced with these recordings. This allows businesses with a voice associated with their brand to make use of that voice talent.

Insofar as embodiments of the invention described above are implementable, at least in part, using an instruction configurable programmable processing device such as a Digital Signal Processor, FPGA, microprocessor, other processing devices, data processing apparatus or computer system or cluster of such systems, it will be appreciated that program instructions for configuring a programmable device, apparatus or system to implement the foregoing described methods is envisaged as an aspect of the present invention. The program instructions (such as, for example, computer program instructions) may be embodied as source code and undergo compilation for implementation on a processing device, apparatus or system, or may be embodied as object code, for example. The skilled person would readily understand that the term computer in its most general sense encompasses programmable devices such as referred to above, and data processing apparatus and computer systems.

Suitably, the program instructions are stored on a carrier medium in machine or device readable form, for example in solid-state memory, magnetic memory such as disc or tape, optically or magneto-optically readable memory, such as compact disk read-only or read-write memory (CD-ROM, CD-RW), digital versatile disk (DVD) etc., and the processing device utilises the program instructions or a part thereof to configure it for operation. The program instructions may be supplied from a remote source embodied in a communications medium such as an electronic signal, radio frequency carrier wave or optical carrier wave. Such carrier media are also envisaged as aspects of the present invention.

Although the invention has been described in relation to the preceding example embodiments, it will be understood by those skilled in the art that the invention is not limited thereto, and that many variations are possible falling within the scope of the invention. For example, methods for performing operations in accordance with any one or combination of the embodiments and aspects described herein are intended to fall within the scope of the invention. Moreover, those skilled in the art will realise that the term “speech” is not limited merely to audible human voice utterances, and may comprise any sound wave generated in any fashion, whether machine-generated, audible or otherwise. Those skilled in the art will realise that the server may be used to provide various system functionality, such as, for example, one or more of: an SQL database, query module, grammar generator, pass-though converter, voice platform etc.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, any number of features from any one or more claims may be combined in any appropriate manner and not merely in the specific combinations enumerated in the claims.

1. A system for creating and hosting user-customised speech-enabled applications, the system comprising:
a client data processing apparatus for use by a user;
a server data processing apparatus operably coupled to the client data processing apparatus; and
a customisation module for configuring a speech interface for one or more applications executable on the system, wherein the customisation module is operable to:
a) receive user input from the client data processing apparatus;
b) determine an appropriate template for configuring the application selected by the user from the user input;
c) retrieve the appropriate template from the server data processing apparatus; and
d) generate configuration data for automatically configuring the speech interface of the application selected by the user when that customised application is executed.

2. The system of claim 1, wherein the server stores the configuration data and hosts the customised application.

3. The system of claim 1, wherein the server is further operable to dynamically generate one or more templates.

4. The system of claim 1, wherein the customisation module is further operable to check for updated templates when applications are executed and preferentially apply updated templates to respective speech-enabled applications.

5. The system of claim 1, wherein the server is further operable to apply multi-channel disambiguation (MCD) to input provided to a customised application in order to disambiguate the configuration data.

6. The system of claim 1, wherein the server is event-driven to automatically execute customised applications in response to input received from one or more application users.

7. The system of claim 1, wherein the server is further operable to generate reports relating to the use of the customised application and transmit them to the user.

8. The system of claim 1, wherein the server is further operable to transmit messages automatically to one or more application users.

9. The system of claim 8, wherein the messages are formatted as one or more of: an SMS message, a radio message and an email message.

10. A method of creating speech-enabled applications having a speech interface customised by a user, the method comprising:
a) receiving user input;
b) determining an appropriate template for configuring an application from the user input;
c) retrieving the appropriate template from a server data processing apparatus; and
d) generating configuration data for automatically configuring a speech interface of an application selected by the user when that customised application is executed.

11. The method of claim 10, further comprising storing the configuration data at the server.

12. The method of claim 10, further comprising dynamically generating at least one template.

13. The method of claim 10, further comprising:
checking for updated templates when applications are executed; and
applying updated templates to speech-enabled applications when updated templates are available.

14. The method of claim 10, further comprising applying multi-channel disambiguation (MCD) to input provided by an application user to a customised application in order to disambiguate the configuration data.

15. The method of claim 10, further comprising automatically executing customised applications in response to input received from one or more application users.

16. The method of claim 10, further comprising:
generating reports relating to the user of the customised application; and
transmitting the reports to the user or participants.

17. The method of claim 10, further comprising transmitting one or more messages automatically to one or more application users.

18. The method of claim 17, wherein the messages are formatted as one or more of: an SMS message, a radio message and an email message.

19. A computer readable medium comprising software instructions for creating and hosting user-customised speech-enabled applications, wherein the software instructions comprise functionality to:
a) receive user input;
b) determine an appropriate template for configuring an application from the user input;
c) retrieve the appropriate template from a server data processing apparatus; and
d) generate configuration data for automatically configuring a speech interface of an application selected by the user when that customised application is executed.

20. The computer readable medium of claim 19, where the software instructions are operable to implement a wizard tool for guiding the user through a customisation process.

21. A computer program product carried on a carrier medium, said computer program product including program code operational to perform:
a) receiving user input;
b) determining an appropriate template for configuring an application from the user input:
c) retrieving the appropriate template from a server data processing apparatus; and
d) generating configuration data for automatically configuring a speech interface of an application selected by the user when that customised application is executed.

22. The computer program product according to claim 21, wherein the carrier medium comprises at least one of the following: a radio-frequency signal, an optical signal, an electronic signal, a magnetic disc or tape, solid-state memory, magnetic memory, optical memory, an optical disc, a magneto-optical disc, a compact disc and a digital versatile disc.

23. (canceled)

24. (canceled)

25. (canceled)

26. (canceled)
